(19) United States
(12) Patent Application Publication
(10) Pub. No.: US 2026/0166464 A1
(43) Pub. Date: Jun. 18, 2026

(54) Methods Of Reprocessing And Assembly Of A Filter Assembly For A Smoke Evacuation Unit

(71) Applicant: Stryker Corporation, Portage, MI (US)

(72) Inventors: Matthew Smith, Parchment, MI (US); Michael Zollinger, Chelsea, MI (US); Nathan Butters, Phoenix, AZ (US); Nicholas Ferentheil, Gilbert, AZ (US); Jason Seiger, Gilbert, AZ (US); Joshua Caleb Colvin, Paw Paw, MI (US); Eric Varty, Mesa, AZ (US)

(73) Assignee: Stryker Corporation, Portage, MI (US)

(21) Appl. No.: 19/420,988

(22) Filed: Dec. 16, 2025

Related U.S. Application Data
(60) Provisional application No. 63/734,928, filed on Dec. 17, 2024.

(51) Int. Cl. B01D 46/88; B01D 46/00; B01D 46/44

(52) U.S. Cl. CPC B01D 46/88; B01D 46/0005; B01D 46/442

(57) ABSTRACT

Methods of reprocessing and assembly of a filter assembly for a smoke evacuation unit. Reprocessing includes accessing a filter chamber of the housing. Filter media is removed from the filter chamber by severing the filter media or an adhesive bond that joins the filter media. A replacement filter media provided, and disposed within the filter chamber to provide a sealed fluid pathway through the replacement filter media. The machined housing may provide a bonding surface, and the replacement filter media may be bonded to the bonding surface. The replacement filter media may be a cartridge including a cartridge housing, and the replacement filter media disposed therein. The step of accessing the filter chamber may include severing a rear side of the housing about a suction outlet, severing rear and front portions of the housing, and/or decoupling a cover from a front of the housing.

### CROSS REFERENCE TO RELATED APPLICATIONS

This application claims priority to and all the benefits of U.S. Provisional Ser. No. 63/734,928 , filed on Dec. 17, 2024, the entire contents of which are hereby incorporated by reference.

### BACKGROUND

Surgical smoke includes aerosolized combustion byproducts produced by heat-generating surgical instruments, such as lasers, electrosurgery, ultrasonic devices, drills, and saws. The smoke produces vapors of aerosolized chemicals and substances that can be hazardous to health, including carcinogenic matter, blood and tissue particles, bacteria, and viruses. Literature suggests that perioperative teams exposed to surgical smoke report twice as many respiratory health issues as the general public. In certain instances, the smoke can be thick enough to obscure vision, especially during longer operations where cauterizing tools are heavily used.

Recent efforts have been directed to reducing and eliminating the presence of surgical smoke in the operating room. A smoke evacuation unit may include a vacuum source, and a replaceable filter assembly may be removably arranged inline between the suction instrument and the vacuum source. The filter assembly includes filter media, such as a high efficiency particulate air (HEPA) filter. The smoke evacuation unit may be implemented as a console situated on a tabletop within the operating room. Other implementations include the smoke evacuation unit being structurally and functionally integrated with a medical waste management system, for example, the Neptune system manufactured by Stryker Corporation (Portage, Mich.) and disclosed in commonly-owned United States Patent Publication No. 2007/0135779, published Jun. 14, 2007, the entire contents of which are hereby incorporated by reference.

The filter assembly should be replaced after its operational life, otherwise its filtration performance may be compromised. Typically, the expended filter assembly is partly or entirely discarded, which contributes to environmental waste. Yet many of the components of the filter assembly may be reusable. Therefore, there is a need in the art for methods of reprocessing the filter assembly for reuse, and to do in a manner that provides filtration performance at least meeting the original device. It would further de desirable to do so to prevent non-genuine components from being used in the reprocessed filter assembly, and assembled in a manner that is not prohibitively expensive to be implemented on a disposable component. Additional shortcomings in the art overcome by the inventive aspects described here will be readily appreciated from this disclosure.

### BRIEF DESCRIPTION OF THE DRAWINGS

FIG. 1 depicts a filter assembly configured to be removably coupled with a smoke evacuation unit of a medical waste collection system. A suction tube of the suction instrument is removably coupled to the filter assembly and a power cord of the suction instrument is removably coupled to a console.

FIG. 2 depicts another exemplary arrangement of the system in which a console includes the electrosurgical unit and the smoke evacuation unit. The suction tube of the suction instrument is removably coupled to the filter assembly and the power cord of the suction instrument is removably coupled to the console.

FIG. 3 is a front right perspective view of a first implementation of the filter assembly configured to be disposed within a filter receptacle of the smoke evacuation unit.

FIG. 4 is a front left perspective view of the filter assembly.

FIG. 5 is a rear right perspective view of the filter assembly.

FIG. 6 is a front right exploded perspective view of the filter assembly.

FIG. 7 is a front left exploded perspective view of another implementation of the filter assembly.

FIG. 8 is an exemplary method of reprocessing the filter assembly.

FIG. 9 is a rear view of the filter assembly depicting a severed opening of a housing.

FIG. 10 is a partially exploded side view depicting a severed rear portion and front portion of the housing of the filter assembly.

FIG. 11 is a partially exploded front left perspective view depicting a decoupled cover and liquid separator from the housing of the filter assembly.

FIG. 12 is a front right perspective view depicting a filter media cartridge and a cartridge housing within the filter assembly.

FIG. 13 is a sectional elevation view depicting a plurality of complementary surfaces in a stepwise configuration separating the housing into a rear portion and a front portion.

FIG. 14 is a front left perspective view of the filter assembly depicting another implementation of the severed opening of the housing with removable filter layers.

FIG. 15 depicts a mill as machining equipment used to machine a layer from inner surfaces of the housing.

FIG. 16 is an exemplary method of assembling the filter assembly.

### DETAILED DESCRIPTION

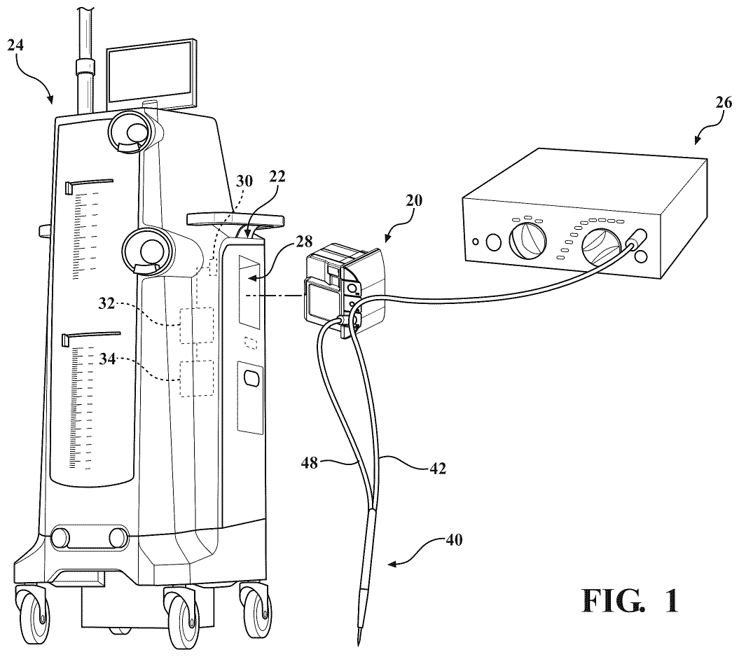

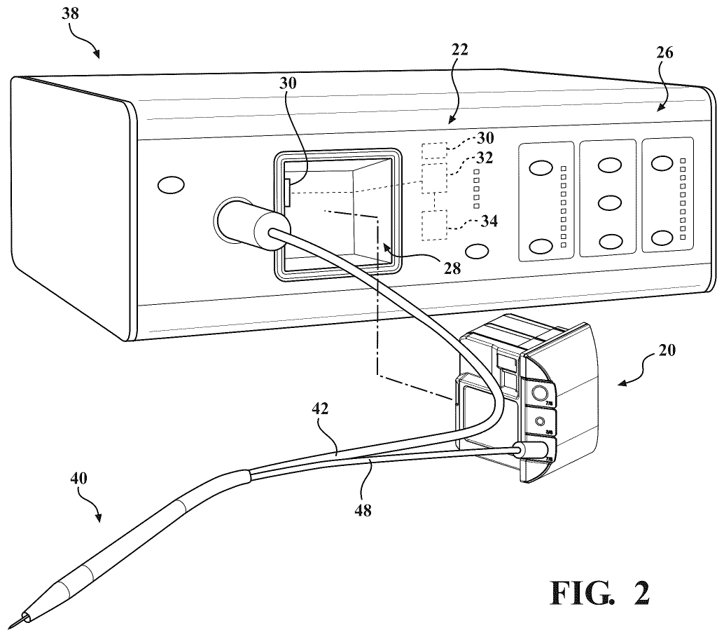

FIGS. 1 and 2 illustrate exemplary arrangements of a filter assembly 20 for use with a smoke evacuation unit 22 of a medical waste collection system 24, and an electrosurgical unit 26. The smoke evacuation unit 22 includes a filter receptacle 28 within which the filter assembly 20 is configured to be removably coupled. FIG. 1 depicts the smoke evacuation unit 22 integrated on a medical waste collection system 24, for example, a wheeled cart supporting one or more waste canisters for collecting liquid medical waste under the influence of suction provided by an electronically controlled vacuum source 34. The electrosurgical unit 26 may be provided as a console 38 separate from the medical waste collection system 24. FIG. 2 depicts an alternative arrangement in which a console 38 includes the smoke evacuation unit 22 and the electrosurgical unit 26. Still another example includes the console 38 providing only for smoke evacuation, such as the SafeAir Compact Evacuator sold by Stryker Corporation.

The electrosurgical unit 26 is configured to operate an electrosurgical instrument 40 to, among other things, cauterize, resect, or augment tissue with electrical energy. One suitable electrosurgical instrument 40 is the SafeAir Smoke Evacuation Pencil sold by Stryker Corporation and disclosed in commonly owned International Patent Publication No. WO2013/000465, published Jan. 3, 2013, the entire contents of which are hereby incorporated by reference. A suction tube 48 couples the electrosurgical instrument 40 to the filter assembly 20, and a power cord 42 couples the electrosurgical instrument 40 to the electrosurgical console 38. For reasons to be described, the power cord 42 may be routed to be positioned near or adjacent the filter assembly 20 to where the suction tube 48 is coupled to the filter assembly 20.

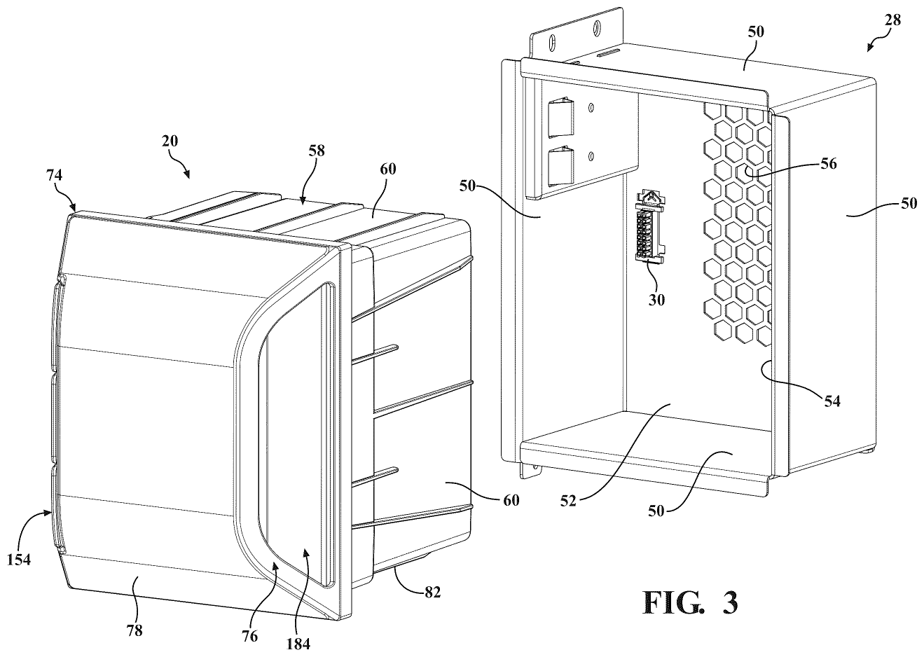

Referring to FIG. 3, the filter receptacle 28 may be formed by a plurality of side barriers 50 defining a filter opening 54, and a rear barrier 52. The rear barrier 52 defines an outlet opening 56 through which suction is drawn on the filter assembly 20 disposed therein. The outlet opening 56 is in fluid communication with the vacuum source 34 through suitable ducting, conduits, or the like. An electronic connector 30 may be disposed on or coupled to the rear barrier 52 of the filter receptacle 28. The electronic connector 30 may be, for example, a plug including a plurality of pins through which power, data, and/or other signals are configured to be transmitted to and from the filter assembly 20.

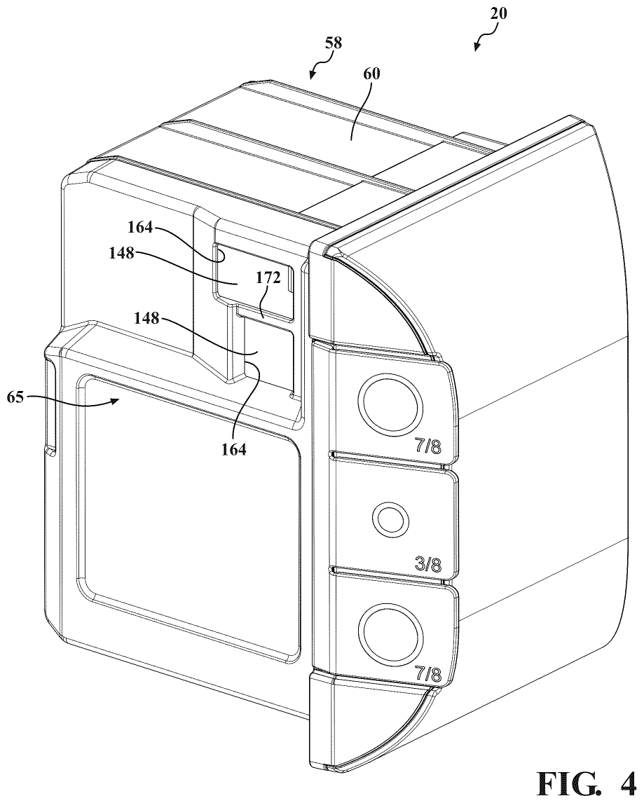

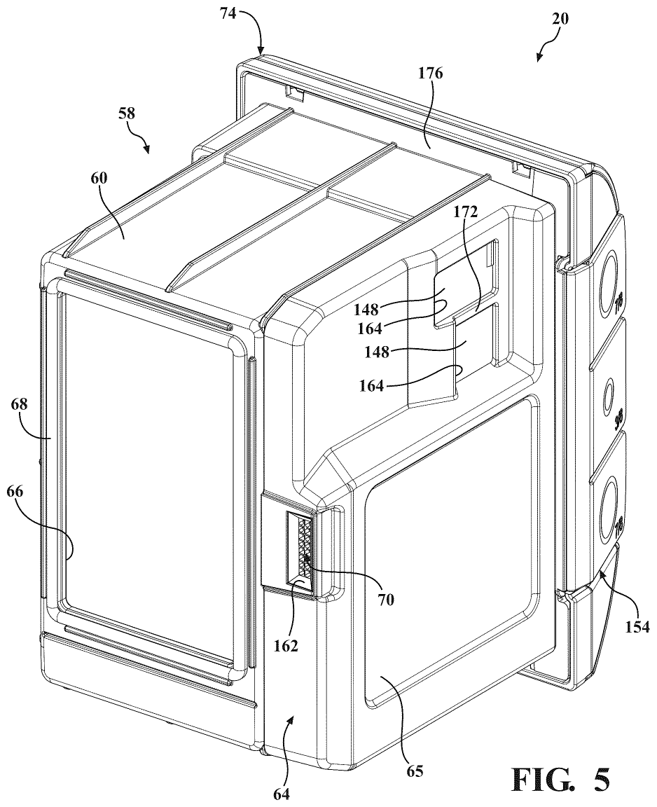

With further reference to FIGS. 4 and 5, the filter assembly 20 includes a housing 58. A rear side 64 of the housing 58 defines a suction outlet 66 sized and shaped complementary to the outlet opening 56 of the filter receptacle 28, and a seal 68 may be disposed about the suction outlet 66 to facilitate a sealed pathway between the suction outlet 66 and the outlet opening 56. The seal 68 may be a rope or cord seal protruding proximal to the rear side 64 so as to directly contact the rear barrier 52 with the filter assembly 20 fully inserted into the filter receptacle 28. An electronic connector 70 may be disposed on or coupled to the rear side 64 of the filter assembly 20. The electronic connector 70 is configured to engage the electronic connector 30 of the smoke evacuation unit 22 to facilitate the transmission of power, data, and other signals therebetween.

The housing 58 may include a plurality of sides 60, 62, 64 arranged in a shape generally complementary to a shape of the filter opening 54 of the filter receptacle 28. The sides 60, 62, 64 may be of monolithic construction through a suitable manufacturing process such as injection molding, blow molding, or the like. The illustrated implementation shows the sides 60, 62, 64 providing a box-shaped form factor to the housing 58 complementary to the box-shaped cavity of the filter receptacle 28. Other complementary geometries are contemplated, including circular, elliptical, rectangular, and higher-order polygonal shapes.

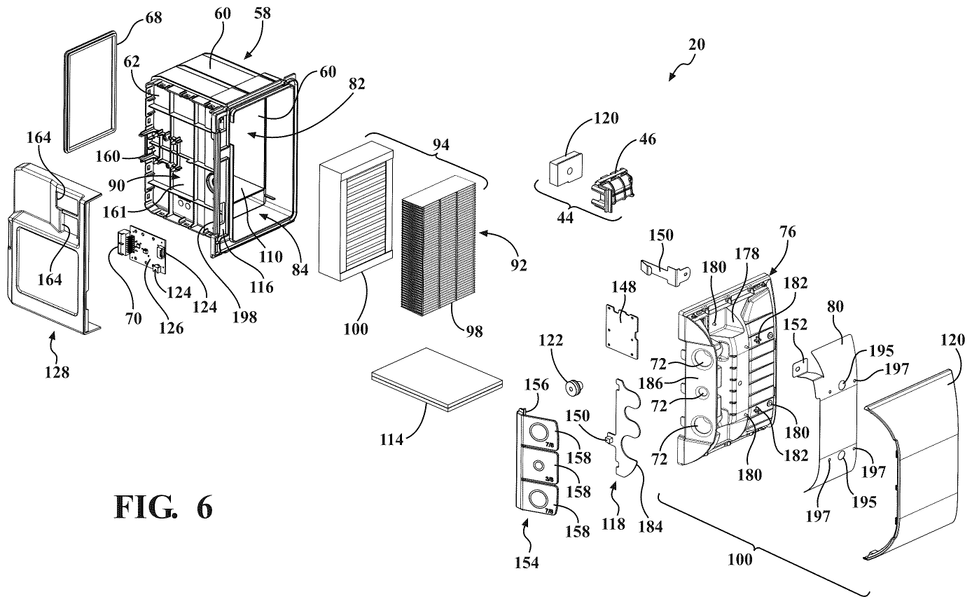

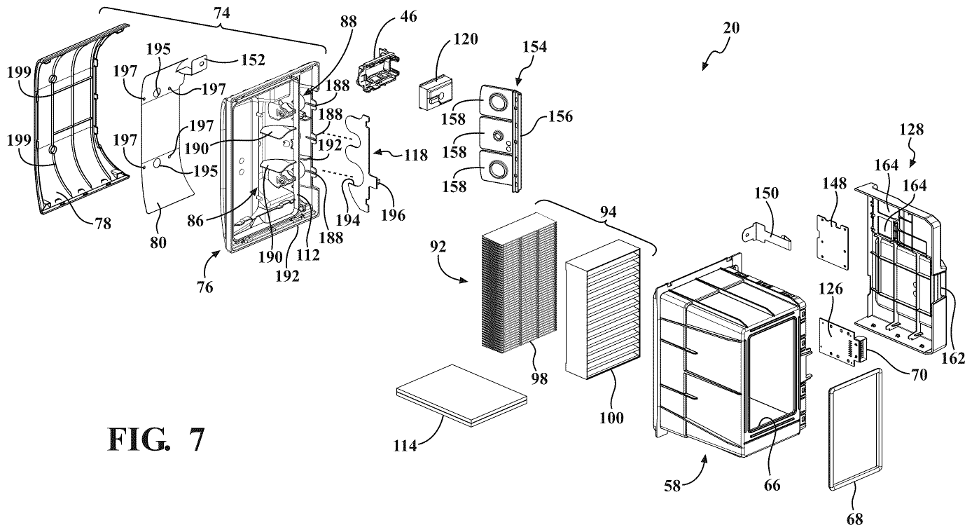

As best shown in FIGS. 6 and 7, the housing 58 includes a partition 110 separating a filter chamber 82 from a liquid collection compartment 84. The liquid collection compartment 84 is disposed below or beneath the filter chamber 82. The partition 110 may extend in a generally horizontal orientation from the rear side 64 and between the opposing sides 60, 62. The partition 110 may also be of monolithic construction with the sides 60, 62, 64 so as to be devoid of seams or interfaces therebetween to prevent liquid egress from the liquid collection compartment 84, particularly during removal and handling of the filter assembly 20. A sorbent 114, such as foam media or super-absorbing polymer, is disposed in the liquid collection compartment 84. The housing 58 may be further formed with webbing 160, and a flange 116 to be described. An aperture 161 may be defined in the side 62 of the housing 58.

An electronics cover 128 is coupled to the side 62 of the housing 58 to define an electronics compartment 90. The electronics cover 128 may be formed from polymeric material from a suitable manufacturing process such as injection molding. The electronics cover 128 and the housing 58 may be fixedly or removably coupled to one another through a suitable joining process, such as clips, fasteners, ultrasonic welding, or the like. A printed circuit board (PCB) unit 126 is supported within the electronics compartment 90, in particular, with the webbing 160 extending from the side 62 of the housing 58. The electronic connector 70 may be coupled to or formed with the PCB unit 126. A rear of the electronics cover 128 may define a slot 162 sized to accommodate the electronic connector 70 with the PCB unit 126 being supported on the webbing 160, as generally appreciated from FIGS. 5 and 7.

The electronics cover 128 may form an outer side 65 of the filter assembly 20 and include a step 170 extending inwardly to define a cutout or recess. The size and shape of the recess may be complementary to the features of the filter receptacle 28. As a result, the shape of the rear side 64 effectively require the user insert the filter assembly 20 into the filter opening 54 of the receptacle 28 in a single orientation. The electronics cover 128 may define one or more windows 164 above the step 170. A contact pad 148 is disposed within the electronics compartment 90, and more particularly secured to an inner surface of the electronics cover 128. For example, the contact pad 148 may be heat staked to the inner surface. At least a portion of the contact pad 148 is exposed through the windows 164. The contact pad 148 is formed from conductive material, for example, a plate of metal. In certain implementations, the electronics cover 128 is further formed with a rib 172 separating the windows 164, and a ridge 173 adjacent to the windows 164 to provide a defeatable retention feature with a complementary component of the filter receptacle 28.

A cover 74 is coupled to the housing 58 to collectively form an enclosure of the filter assembly 20. In particular, the cover 74 may be fixedly or removably coupled to front edges of the sides 60, and to the flange 116 of the housing 58. The coupling may be effectuated with, for example, adhesive, fasteners, clips, laser or ultrasonic welding, or other suitable joining means. In certain implementations, a gasket may be disposed between the cover 74 and the housing 58 to provide a sealed interface and prevent egress of liquid. The cover 74 is sized slightly larger than the housing 58 so as to form a lip 176 or flange configured to abut a front edge of the filter receptacle 28 with the filter assembly 20 fully inserted therein.

The cover 74 includes an inner casing 76 formed from plastic or similar composite material and from a suitable manufacturing process such as injection molding. The inner casing 76 be formed with a recess 178, stakes 180, and alignment posts 182. One of the stakes 180 may be located within the recess 178 for assembly steps to be described. Further, the inner casing 76 is formed with one or more inlet ports 72, and a port cover component 154 is secured to the inner casing 76. As best shown in FIG. 6, the inner casing 76 is formed with a recessed face 186 having a thickness approximating a thickness of the port cover component 154. The port cover component 154 may include a spine 156 and one or more flaps 158 sized to cover a respective one or the inlet ports 72. The spine 156 of the port cover component 154 is secured to tabs 188 extending proximally from an edge of the inner casing 76. The port cover component 154 may be integrally formed from a rubber or similar polymeric material such the flaps 158 resiliently deflect to expose the inlet ports 72 for coupling of a suction tube. In optional implementation, the flaps 158 are at least partially formed from conductive material(s) configured to limit, dampen, reduce, or prevent changes in electric field therethrough.

A rear of the inner casing 76 may be formed with a partition 112 separating a smoke ingress compartment 86 from a sensor compartment 88. As best shown in FIG. 7, the inner casing 76 may be formed with baffles 190 within the smoke ingress compartment 86, and the inlet ports 72 may extend within the smoke ingress compartment 86 below the baffles 190. The inner casing 76 may be formed with webbing or geometries 192 for supporting a sensor 118 disposed within the sensor compartment 88. FIG. 7 shows the geometries 192 including a groove near a bottom of the sensor compartment 88, and fins on inner surfaces within the sensor compartment 88.

The cover 74 is further formed with a handle 184 for manipulating the filter assembly, such as installing into or removing from the receptacle, or otherwise carrying it about the medical facility. As best shown in FIG. 3, the handle 184 may be provided by a cavity formed into the inner casing 76 with the cavity having a width and depth to ergonomically accommodate a hand of the user. The handle 184 is opposite the port cover component 154. It is appreciated that the aforementioned structures of the inner casing 76, including the recess 178, the stakes 180, alignment posts 182, the recessed face 186, the tabs 188, geometries 192, and the handle 184, may form a unitary, monolithic structure forming the inner casing 76.

The sensor 118 is supported within the sensor compartment 88 with the geometries 192, and an optional adhesive or fastener may secure the sensor 118 therein. Alternatively, the sensor 118 may be coupled to the inner casing 76 through other suitable joining means. The sensor 118 is configured to detect changes in the electric field (e.g., changes in radiofrequency (RF) or other EM energy), in particular changes in alternating current (AC) flowing through the power cord 42 of the electrosurgical instrument 40. In a preferred implementation, the sensor 118 is a capacitive sensor, also considered an antenna, reader, transceiver, e-field sensor, or the like.

In certain implementations, it may be desirable for the sensor 120 to be maximally sized to increase sensor resolution. With continued reference to FIGS. 6 and 7, the sensor 118 is slidably inserted into the sensor compartment 88 to be positioned adjacent to and aligned with an inner surface of the recessed face 186 through which the inlet ports 72 are defined. The sensor 118 includes a curvilinear edge 194 contoured to the inlet ports 72 such that the sensor 118 is sized and shaped to most or nearly an entirety of the inner surface of the recessed face 186. The sensor 118 may be plate-like in shape and generally monolithic in structure.

The sensor 118 is in electronic communication with the electronic connector 70 of the filter assembly 20 The sensor 118 includes a tab, and an electronic socket 196 is coupled to the tab. The electronic socket 196 extends through a slot 198 defined by the flange 116 of the housing 58. A wire harness (not shown) includes plugs coupling the electronic socket of the sensor 118 to another socket 124 of the PCB unit 126. With electronic communication established between the sensor 118 and the controller 32 of the smoke evacuation unit 22, the controller 32 is configured to control the vacuum source 34 of the smoke evacuation unit 22 based on the energizing, deenergizing, and adjusting energy provided to the electrosurgical instrument 40 (or other powered surgical instrument or device) as detected by the sensor 118.

To ensure that the changes in the electric field are attributable to the electrosurgical instrument 40 (and not electromagnetic noise), the cover 74 may optionally be shielded configured to reduce, dampen, limit, or prevent potential EM noise from entering the housing 58 to be detected by the sensor 118. Hereinafter referred to as the shielding cover 74, the shielding cover 74 includes a shielding layer 80 is at least partially formed from conductive material configured to reduce, dampen, limit, or prevent changes in electric field therethrough. With continued reference to FIGS. 6 and 7, the shielding layer 80 may be a thin plate contoured to a portion of the outer surface of the inner casing 76. The shielding layer 80 is secured to the outer surface of the inner casing 76 with the stakes 180 previously mentioned. In particular, the shielding layer 80 may be formed to define alignment apertures 195 and staking apertures 197. As implied by their names, the alignment apertures 195 are aligned with the alignment posts 182 of the inner casing 76 for the stakes 180 extend through and be staked to the staking apertures 197.

A conductive flange 152 and an end of a conductive bridge 150 is secured to the stake 180 disposed within the recess 178 of the inner casing 76, for example, via heat staking. The conductive bridge 150 includes at least one bend configured to traverse about an edge geometry of the inner casing 76 to be aligned with the side 62 of the housing 58. The opposing end of the conductive bridge 150 is in electrical communication with the contact pad 148 of the housing 58. For example, a bend of the conductive bridge 150 may also include a spring element or a bend shaped to cause resilient direct contact with an inner surface of the contact pad 148. In another example, the conductive bridge 150 is soldered to the contact pad 148 with a finger or wire lead. As a result, the contact pad 148 is in electrical communication with the shielding layer 80, and therefore the shielding cover 74 is configured to be grounded; i.e., electrically coupled to ground such as protective earth, through engagement with the filter receptacle 28.

An outer casing 78 is fixedly or removably coupled to the inner casing 76 to sandwich the shielding layer 80 therebetween. An inner surface of the outer casing 78 may be formed with alignment divots 199 aligned with the alignment posts 182 of the inner casing 76 through the alignment apertures 195 of the shielding layer 80. The outer casing 78 formed from plastic or similar composite material and from a suitable manufacturing process such as injection molding. The outer casing 78 and the inner casing 76 through clips, fasteners, ultrasonic welding, or the like.

Returning to the housing 58 and with reference to FIG. 6, the filter chamber 82 is defined by inner surfaces of the sides 60, 62 of the housing 58, and the partition 110. Filter media 92 is disposed within the filter chamber 82. The illustrated implementation shows the filter chamber 82 being square or rectangular in section, and the filter media 92 complementarily shaped to provide a fluid-tight seal. The filter media 92 may be larger than the filter chamber 82 thereby resiliently compressing the filter media 92 to create the fluid-tight seal. Additionally or alternatively, an adhesive bond or gasket may be the filter media 92 and the inner surfaces of the sides 60, 62, 110 to provide the fluid-tight seal.

The filter media 92 is a filter stack 94 including a plurality of filter layers, each providing a specific purpose in the filtration process. A first filter layer 96 may act as a prefilter, capturing larger particles, a second filter layer 98 may be an ULPA filter which removes ultra-fine particles from the surgical smoke, and a third filter layer 100 may be a charcoal filter including a sorbent or catalyst to remove odors from gaseous pollutants such as volatile organic compounds or ozone. The filter stack 94 may include additional prefilter and filtering layers.

In certain implementations, a sensor assembly 44, including a second sensor 120, may be disposed with the housing 58 and positioned distal or upstream to the filter media 92. The second sensor 120 may be an optical sensor configured to detect a characteristic of the gas passing through the smoke ingress compartment 86, namely particulates. The sensor assembly 44 includes a sensor housing 46 coupled to an inner wall of the housing 58, and the sensor 120 supported by the sensor housing 46. The sensor 120 is in electronic communication with the PCB unit 126, for example, through a wire or a wire harness extending through a sealed grommet 122 seated within the aperture 166 on the side 62 of the housing 58 to a socket 124 of the PCB unit 126.

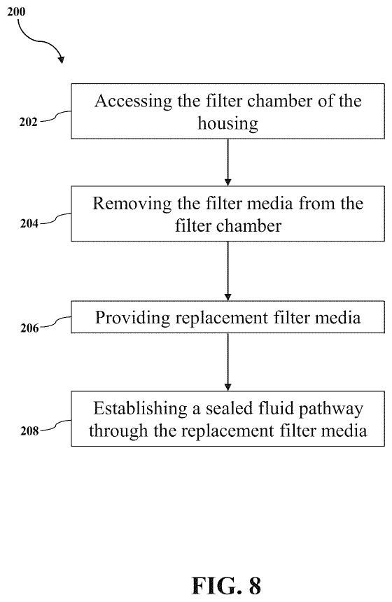

Referring now to FIG. 8, an exemplary method 200 of reprocessing the filter assembly 20 is provided. As mentioned, often the expended filter assembly 20 is partly or entirely discarded its operational life; however, many of the subcomponents may be reusable. The method 200 includes accessing the filter chamber 82 of the housing 58 (step 202), removing the filter media 92 from the filter chamber 82 (step 204), providing the replacement filter media (step 206), and joining the replacement filter media to provide a sealed fluid pathway through the replacement filter media (step 208). Additional optional steps to be described include cleaning one or more of the subcomponents, replacing electronic components, and the like.

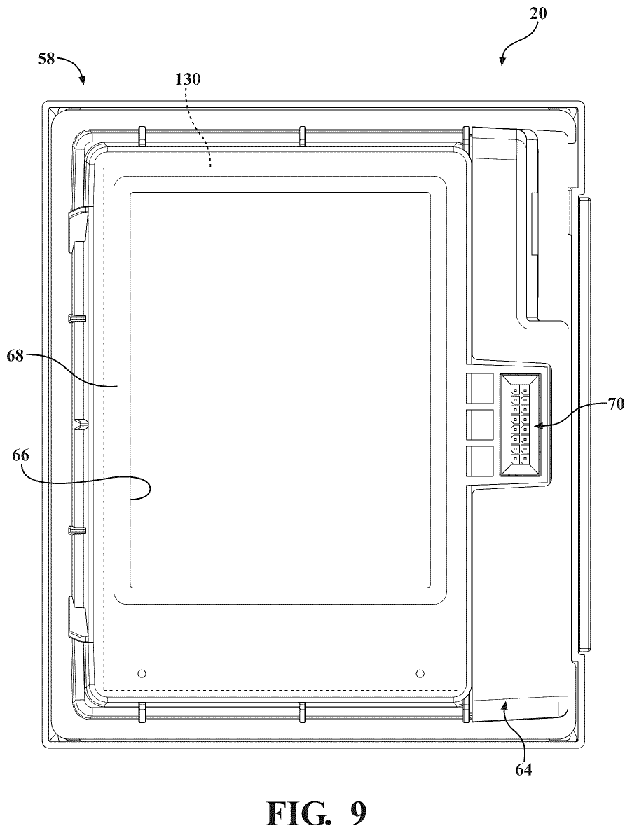

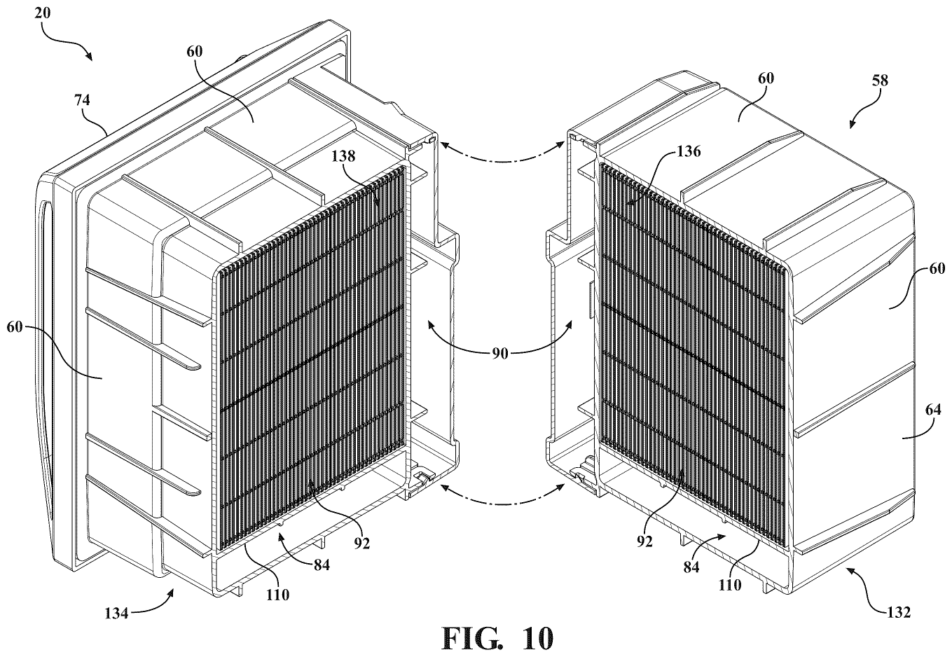

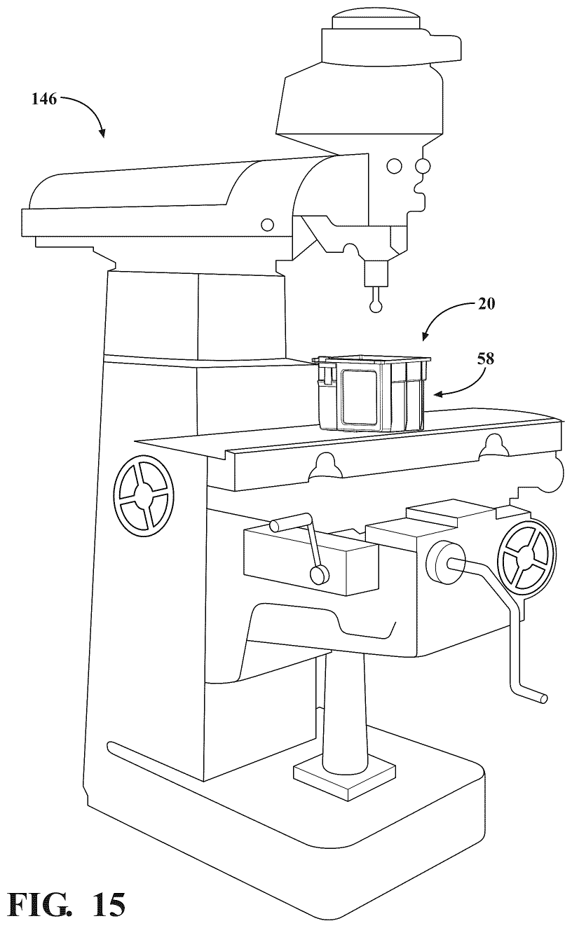

The step 202 of accessing the filter chamber 82 may be accomplished through any one or more of several means to be discussed. In a first implementation seen in FIG. 9, the step 202 may include machining the rear side 64 of the housing 58. For example, the rear side 64 may be machined around the suction outlet 66 to form a severed opening 130 to access the filter media 92. Alternatively, a grate forming the suction outlet 66 may be severed or mutilated. The machining may be performed using industrial machining equipment such as a mill 146 (see FIG. 15), a handheld instrument such a rotary tool, or other suitable devices. The removed piece(s) may be discarded or, if sufficiently preserved, cleaned for reassembly. Additionally or alternatively, the severed opening 130 may also be machined into one of the sides 60, 62 of the housing 58 (see FIG. 10), and/or the cover 74.

The severed opening 130 provides access to the filter chamber 82. The filter media 92 may then be removed from the filter chamber 82 (step 204). The step 204 includes severing the adhesive bond that joins the filter media 92 to the inner surfaces of the sides 60, 62 of the housing 58 and/or severing the filter media 92 itself. As used herein, severing means any manual or machine-based means by which the bonded, joined, connected, or coupled components may be separated, and alternatively may be considered as detaching, decoupling, splitting, dissolving, rupturing, parting, breaking, segmenting, mutilating, ripping, tearing, chiseling, milling, lathing, or the like. In one example, this may be achieved by debulking the filter media 92 then machining a layer of the inner surfaces of the sides 60, 62 of the housing 58 with the mill 146 or other equipment or tools. The machining of the adhesive bond provides a bonding surface. For example, the bonding surface may be a milled surface that is 0.25, 0.5. 1.0 or more millimeters below the inner surface of the sides 60, 62, 110 of the original filter assembly.

In addition to removing the filter media 92, any one or more of the aformentioned subcomponents of the filter assembly 20 may be removed through the severed opening 130. For example, the partition 110 may be severed to access the liquid collection compartment 84, after which the sorbent 114 may be removed. For another example, the sensor assembly 44 may be removed after removal of the filter media 92. The sensor housing 46 may be severed from the housing 58, or the sensor 120 may be decoupled from the sensor housing 46.

In an optional step, the electronics cover 128 may be severed or otherwise decoupled from the housing 58 to access the electronics component 90. The PCB unit 126 may be removed, and/or the wire harness coupled to the electronic socket 196 of the sensor 118 may be decoupled. In another optional step, the housing 58 may be cleaned through a suitable cleaning process, including but not limited to spraying, bathing, rubbing, or the like, disinfectant and other chemical to remove residual smoke and medical waste that may be disposed therein and thereon. Thereafter, still another optional step includes reassembling any removed subcomponents, for example, positioning a replacement sorbent within the liquid collection compartment 84.

The method 200 includes the step 206 of providing the replacement filter media 93. The replacement filter media 93 may be the same size or larger than the dimensions of the filter media 92 that was removed. The replacement filter media 93 is directed through the severed opening 130 to within the filter chamber 82. The step 206 may require compressing of the filter media 92 to be directed through the severed opening 130.

The method 200 further includes the step 208 of sealing the pathway through the replacement filter media 93 to ensure satisfactory filtration performance. In a first variant, the replacement filter media 93 may be joined with the bonding surface. For example, an adhesive may be applied to the bonding surface, and/or to the sides of the replacement filter media 93 prior to insertion into the filter chamber 82. The adhesive provides the sealed pathway between the replacement filter media 93 and the housing 58. In a second variant, a gasket may be coupled to the replacement filter media 93 prior to or after positioning the replacement filter media 93 within the filter chamber 82. The gasket and the bonding surface are in direct contact to provide the sealed pathway. Additionally or alternatively, the replacement filter media 93 may be compressed to position it within the filter chamber 82. Once the replacement filter media 93 is positioned within the filter chamber 82, the compression can then be released to allow the resilient material to expand within the filter chamber 82 to contact the housing 58 and provide a sealed fluid pathway through the replacement filter media 93. The compression may allow the resilient material to expand lengthwise to contact the inner surface of the rear side 64, or widthwise to contact the inner surfaces of the sides 60, 62 of the housing 58. Any other removed subcomponents may be reassembled. Thereafter, the severed opening 130 may then be closed by joining the removed piece(s), or a fabricated replacement portion sized to the severed opening 13. The joining may by means of adhesive, fasteners, clips, ultrasonic welding, or the like.

In another implementation of the method 200, the step of accessing the filter chamber 82 includes severing a rear portion 132 of the housing 58 from a front portion 134 of the housing 58. FIG. 10 depicts machining around the sides 60, 62 of the housing 58. The step 202 may further include severing the filter media 92 into a proximal filter portion 136 and a distal filter portion 138. This may be performed anywhere along the depth of the housing 58. For example, FIG. 10 shows the severing occurring approximately halfway between the cover 74 and the rear side 64. In another variant, the severing may occur at or adjacent to an interface between the housing 58 and cover 74.

Thereafter, the step 204 of removing the filter media 92 from the filter chamber 82 includes removing the proximal filter portion 136 from the front portion 134, and the distal filter portion 138 from the rear portion 132. The removal may be facilitated through the means disclosed herein, such as the mill 146 or other equipment or tool(s). As observed from FIG. 10, the second variant of the method 200 provides access to the sensor compartment 88 for servicing or replacement of the sensor 118 as well as access to the liquid collection compartment 84 for replacement of the sorbent 114. The removal of the distal filter portion 138 may also provide access to the sensor assembly 44.

Once the proximal filter portion 136 and the distal filter portion 138 are removed from the respective rear portion 132 and front portion 134 of the housing 58, the step 206 of providing the replacement filter media 93 may include directing the replacement filter media 93 through one or more of the severed rear portion 132 and front portion 134 of the housing 58. The sealed pathway is provided (step 208) through adhesive, gasket, or the like, and the rear portion 132 and the front portion 134 may be rejoined by means of adhesive, fasteners, clips, ultrasonic welding, or the like.

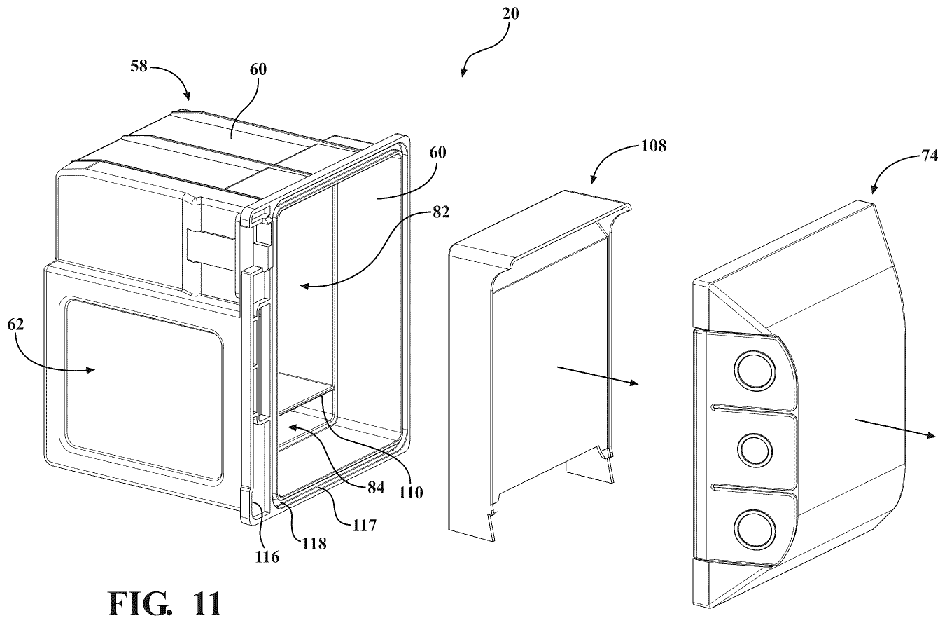

FIG. 11 depicts another implementation of the method 200 in which the step 202 of accessing the filter chamber 82 includes decoupling the cover 74 from the housing 58. An interface 117 about the periphery of the housing 58 and cover 74 may be severed through suitable means, such as machine, drilling, prying, or the like. The gasket (not shown) may be removed from a channel 119 of the interface 117. Thereafter, the filter chamber 82 is accessible, and the sensor compartment 88 is also accessible for removal and replacement of the sensor 118, if necessary. In certain optional implementations, a liquid separator 108 may be decoupled and removed to access the filter chamber 82 (and the liquid collection compartment 84). The liquid separator 108 may be severed the partition 110 and/or the sides 60 of the housing 58.Once the cover 74 (and the liquid separator 108, if applicable) is decoupled from the housing 58, the filter media 92 is removed from the filter chamber 82 (step 204) and the sealed pathway with the replacement filter media 93 (step 206) is provided in any of the manners previously described.

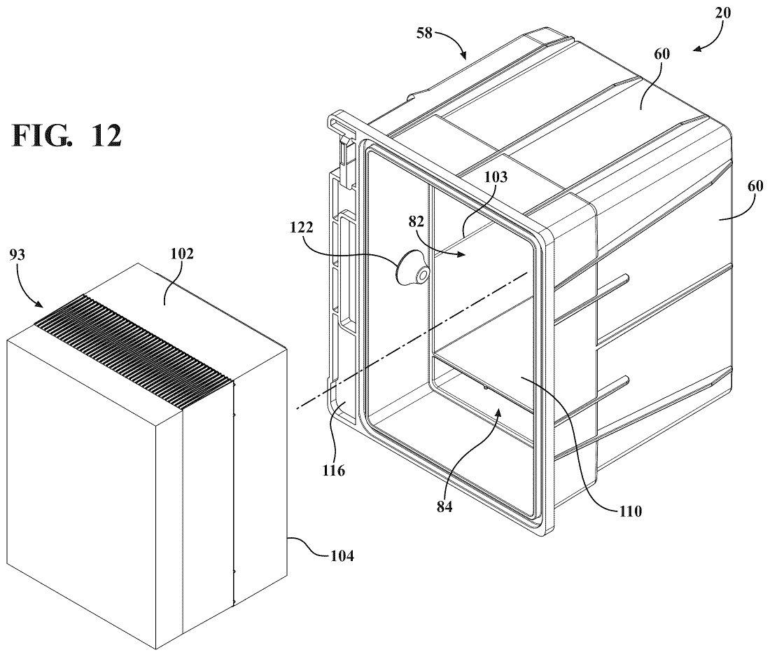

In a variant of the step 206 of sealed pathway, the replacement filter media is a replacement filter media cartridge 93. The filter media cartridge 93 may include a cartridge housing 104, and the replacement filter media 102 supported therein. The cartridge housing 104 may be formed from resilient material, such as a rubber struts forming a cage-like structure, as shown in FIG. 12, to bound the replacement filter media 102. The outer dimensions of the cartridge housing 104 may approximate (i.e., equal to or slightly larger than) the inner dimensions of the filter chamber 82. Optionally, the housing 58 may be machined to provide contours or geometries 103 configured to receive a portion of the cartridge housing 104 to provide the sealed fluid pathway. It should be appreciated that the replacement filter media cartridge 93 may be used with any of the aforementioned implementations regardless of how access to the filter chamber 82 is achieved.

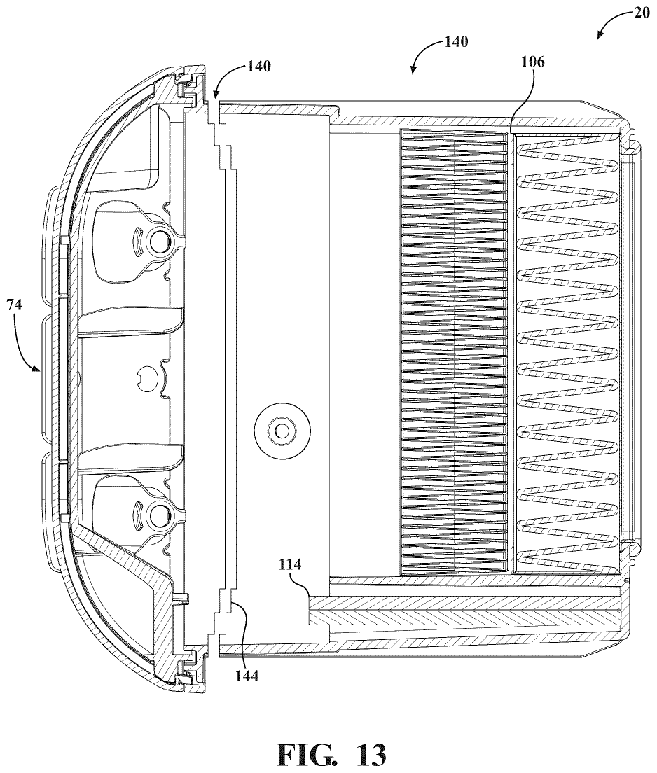

FIG. 13 depicts another implementation of the method 200 to provide means for repeated reprocessing the filter assembly 20, thereby extending the longevity of the subcomponents of the filter assembly 20. In particular, the front portion 134 may be coupled to the rear portion 132 with one or more bonded joints 140 utilizing adhesive or other coupling means to bond a plurality of complementary surfaces 142, also referred to as bonding surfaces. These complementary surfaces 142 may be radially and/or axially offset from the one or more bonded joints 140 in a stepwise configuration and may be coaxially disposed within and axially aligned with the bonded joints 140. The complementary surfaces 142 may be a part of one or more of the plurality of sides 60, 62, 64 of the housing, or any suitable location for creating the bonded joints 140. One or more spacer elements 144 may be joined between the complementary surfaces 142 with a thickness approximating the axial offset. Accessing the filter chamber 82 of the housing 58 (step 202) may be achieved by severing one or more of the bonded joints 140 to decouple the front portion 134 from the rear portion 132, exposing complementary surfaces 142 that are abutting but not mated during manufacturing. Each instance of reprocessing of the filter assembly 20 may involve severing the bonded joints 140 and joining newly exposed complementary surfaces 142. The filter media 92 may be removed (step 204), and the replacement filter media 93 is directed into the filter chamber 82 (step 206) to provide the sealed pathway (step 208). Thereafter, the front portion 134 is reattached to the rear portion 132 by joining the subsequent complementary surfaces 142 utilizing adhesive or other coupling means to recreate the bonded joints 140.

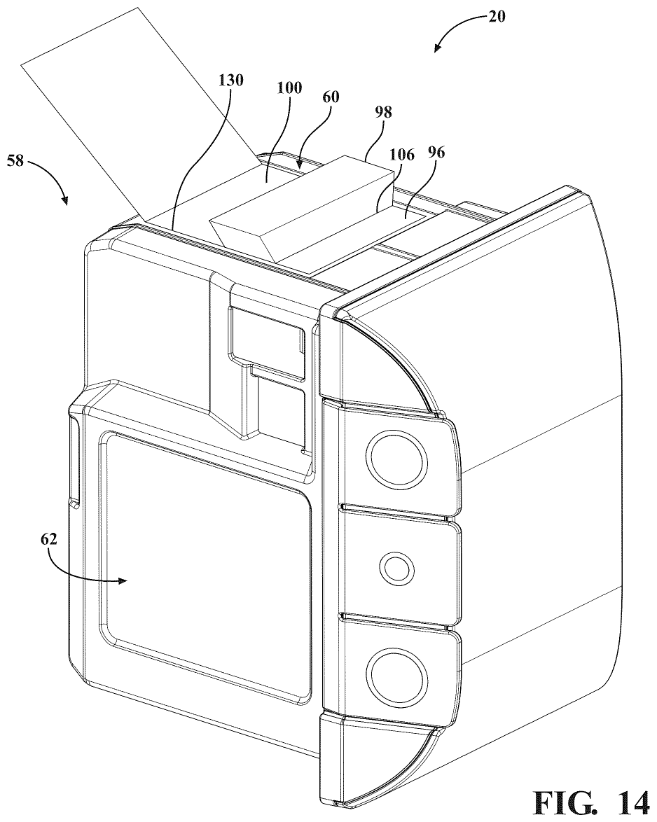

In certain implementations, the filter stack 94 may not require replacement, rather one or more of the filter layers 96, 98, 100 of the filter stack 94 may be individually replaceable. For example, certain filter layers 96, 98, 100 may degrade more quickly than others, and therefore it would be desirable to only replace the filter layer(s) 96, 98, 100 necessitating the same. Access to the filter chamber 82 may be achieved through any of the manners previously described (e.g., through a severed opening 130, through the severed rear portion 132, front portion 134, etc.). FIG. 14 shows the filter stack 94 being accessed through the severed opening 130 within a top side of the housing 58. At least one of plurality of the filter layers 96, 98, 100 may be removed while others remain within the filter chamber 82. The individual filter layers 96, 98, 100 include a frame (not shown) slidably within rails formed into the housing 58. One or more sealing elements 106 disposed between the plurality of filter layers 96, 98, 100 of the filter stack 94 to maintain the sealed fluid pathway after replacement of one or more of the individual filter layers 96, 98, 100. Alternatively, the sealing elements 106 may be removable.

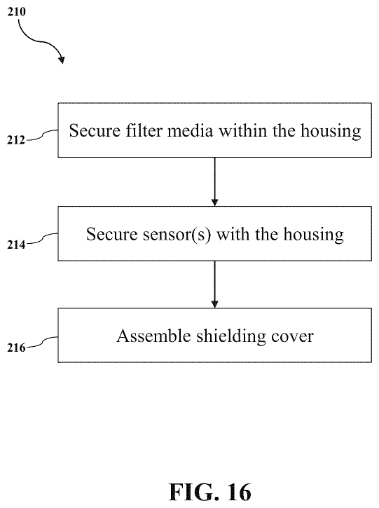

Certain inventive aspects of the present disclosure are further directed assembly of the filter assembly 20. An exemplary method 210 of assembly of the filter assembly 20 is shown in FIG. 16. The components and subcomponents of the filter assembly 20 described throughout the present disclosure are hereby incorporated by reference and not reintroduced in the interest of brevity. The method 210 includes the steps of assembling the filter media 92 with the housing 58 (step 212), assembling the sensor(s) 118, 120 with the housing 58 (step 214), and assembling the shielding cover 74 (step 216).

The housing 58 and the electronics cover 128 are provided as formed, monolithic components with the geometries and features described herein. The contact pad 148 is provided and secured to the inner side of the electronics cover 128 to be exposed through the windows 164. In an exemplary step, the contact pad 148 is heat staked to staking posts extending inwardly from the inner side of the electronics cover 128.

The filter media 92 is provided in which the filter layers 96, 98, 100 are preassembled into the filter stack 94. The step 212 includes inserting filter stack 94 into the filter chamber 82. An adhesive is applied to inner surfaces of the sides 60, 62 (and an upper surface of the partition 110), and/or to the outer surfaces of the filter layers 96, 98, 100. The adhesive cures to provide the sealed interface between the filter stack 94 and the housing 58. Optionally, the filter stack 94 may be resiliently compressed prior to positioning it within the filter chamber 82. The sorbent 114 may be positioned within the liquid collection compartment 84 of the housing 58.

The step 216 of assembling the sensor(s) 118, 120 includes coupling the sensor 120 to the sensor housing 46 to form the sensor assembly 44. The sensor assembly 44 is secured to the housing 58, for example, with a clip or other suitable retention feature. A wire extending from the sensor 120 is fed through the sealed grommet 122 and through the aperture 161 in the side 62. The sealed grommet 122 is seated within the aperture 161. In the optional implementation where the filter assembly 20 includes the liquid separator 108, the liquid separator 108 may be inserted into the housing 58 secured into place by means of adhesive, fasteners, clips, ultrasonic welding, or other suitable joining means. The step 216 further includes positioning the sensor 118 within in the sensor compartment 88. The sensor 118 may be slidably directed from a rear of the inner casing 76, and an adhesive or other retention feature may be used to secure the sensor 118 therein. A wire may be coupled to the sensor 118 and directed through the slot 198 of the flange 116 of the housing 58. Alternatively, the inner casing 76 may be secured to the housing 58, after which the sensor 118 is directed through the slot 198 of the flange 116 and into the sensor compartment 88.

The step 218 of assembling the shielding cover 74 includes securing the inner casing 76 to the housing 58 with adhesive, or with fasteners, clips, laser or ultrasonic welding, or other suitable joining means. The shielding layer 80 is secured to the inner casing 76, and in particular to the outer surface of the inner casing 76 with the stakes 180. In particular, the shielding layer 80 may be formed to define alignment apertures 195 and staking apertures 197. The alignment apertures 195 are aligned with the alignment posts 182 of the inner casing 76 for the stakes 180 extend through and be staked to the staking apertures 197. The conductive flange 152 is positioned within the recess 178 of the inner casing 76 with the one of the stakes 180 extending therethrough. The conductive flange 152 and the conductive bridge 150 are heat staked to the stake 180, or soldered to one another to establish electrical communication. The conductive bridge 150 may be forcibly bent to traverse the edge geometry, or the conductive bridge 150 may be pre-bent to or formed as a suitable shape. The opposing end of the conductive bridge 150 is manipulated to directly contact the contact pad 148 of the housing 58. Alternatively, a conductive finger or electrical lead may be provided and soldered to each of the contact pad 148 and the shielding layer 80.

The outer casing 78 is secured to the inner casing 76. The alignment divots 199 are aligned with the alignment posts 182 of the inner casing 76 through the alignment apertures 195 of the shielding layer 80, and the outer casing 78 is secured to the inner casing 76 through adhesive clips, fasteners, ultrasonic welding, or the like. In an alternative implementation, the shielding layer 80 and/or the outer casing 78 may be secured to the inner casing 76 to form the shielding cover 74 for the shielding cover 74 to be secured to the housing 58 as an assembly. The port cover component 154 is secured to the inner casing 76, either prior to or after the shielding cover 74 is secured to the housing 58. In particular, the spine 156 of the port cover component 154 may be secured to the tabs 188 extending proximally from an edge of the inner casing 76.

The step 216 of assembling the sensor(s) 118, 120 may also include assembling the associated electrical and electronic components. For example, the PCB unit 126 may be installed onto the webbing 160 extending from the side 62 of the housing 58 such that the electronic connector 70. The wire extending from the sensor 120 through the sealed grommet 122 is coupled to one of the sockets 124 of the PCB unit 126, and the wire extending from the sensor 118 is coupled to another one of the sockets 124 of the PCB unit 126. The electronics cover 128 may be secured to the housing 58 with adhesive, clips, fasteners, ultrasonic welding, or the like. The electronics cover 128 is secured to the side 62 of the filter assembly 20 such that the electronic connector 70 is supported in the slot 162 on the rear of the electronics cover 128. Further, the coupling may ensure the electrical contact between the shielding layer 80 and the contact pad 148.

Several embodiments have been discussed in the foregoing description. However, the implementations discussed herein are not intended to be exhaustive or limit the method of reprocessing the filter assembly 20 for reuse to any particular form. The terminology which has been used is intended to be in the nature of words of description rather than of limitation. Many modifications and variations are possible in light of the above teachings and the method may be practiced otherwise than as specifically described. Further, it should be appreciated that the steps of the methods 200, 210 disclosed herein may be performed in any suitable order unless otherwise indicated.

In an alternative implementation, both of the sensors 118, 120 and the PCB unit are supported on the cover 74 to simplify reprocessing. Certain additional inventive methods of the implementation are described with reference to the following exemplary clauses:
Clause 1—A method of reprocessing components of a filter assembly for a smoke evacuation unit, wherein the filter assembly includes a housing, a shielding cover coupled to the housing to define a filter chamber, filter media bonded to the housing, an electric field sensor, a sensor, and a printed circuit board (PCB) unit, the method comprising: decoupling the shielding cover from the housing, wherein the electric field sensor and the PCB unit are secured to an inner side of the shielding cover and are removed from the filter chamber with the decoupling of the shielding cover; severing the shielding cover to sever the electric field sensor and the PCB unit from the inner side of the shielding cover; providing a replacement shielding cover, wherein the shielding cover includes a shielding layer formed from conductive material and configured to prevent changes in electric field therethrough; joining the electric field sensor and the PCB unit to the inner side of the replacement shielding cover; providing a replacement housing, and replacement filter media bonded to the housing; and coupling the replacement shielding cover to the replacement housing.
Clause 2—The method of clause 1, further comprising decoupling a wire connector from the electric field sensor; and coupling a replacement wire connector associated with the replacement housing to the electric field sensor.
Clause 3—The method of clause 1 or 2, wherein the filter assembly includes a sensor disposed within the filter chamber, and a liquid separator coupled to the housing, the method further comprising: decoupling the liquid separator from the housing to access the filter chamber; and decoupling the sensor from the housing; and coupling the sensor to the replacement housing.
Clause 4—The method of clause 3, further comprising: decoupling a wire connector from the sensor prior to the step of decoupling the sensor from the housing; and coupling a replacement wire connector associated with the replacement housing to the sensor.
Clause 5—A method of reprocessing for reuse a filter assembly for a smoke evacuation unit, wherein the filter assembly includes a housing comprising a rear side defining a suction outlet, and sides extending from the rear side, a cover coupled to the sides to define a filter chamber, filter media bonded to inner surfaces of the sides, an electric field sensor, and a sensor, the method comprising: accessing the filter chamber of the housing by machining the housing to sever a rear portion of the housing from a front portion of the housing; removing at least a filter layer the filter media from the rear portion and the front portion; providing replacement filter media, wherein the replacement filter media is joined to at least one of the rear portion and front portion; and at least one of (i) rejoining the rear portion with the front portion, and (ii) joining a replacement rear portion to the front portion to provide a sealed pathway through the replacement filter media.
Clause 6—The method of clause 5, wherein the step of accessing the filter chamber further comprises machining the rear side of the housing and around the suction outlet.
Clause 7—The method of clause 5, wherein the step of accessing the filter chamber further comprises machining around the sides of the housing.
Clause 8—The method of clause 7, wherein the severing of the rear portion of the housing further severs the filter media into proximal and distal filter portions, wherein one of the proximal and distal filter portions remains within the housing to be reused, and the other one of the proximal and distal filter portions is replaced with the replacement filter media.
Clause 9—The method of any one of clauses 5-8, further comprising: decoupling a wire of the sensor from the PCB unit; and removing and replacing the sensor with a replacement sensor.
Clause 10—A method of reprocessing for reuse a filter assembly for a smoke evacuation unit, wherein the filter assembly includes a housing comprising a rear portion defining a suction outlet, and a front portion coupled to the rear portion with one or more bonded joints, a cover coupled to the front portion to define a filter chamber, filter media disposed within the filter chamber, an electric field sensor, and a sensor, the method comprising: accessing the filter chamber of the housing by severing one or more of the bonded joints to decouple the front portion from the rear portion, wherein the decoupling exposes one or more complementary surfaces that are abutting but not mated during manufacturing of the filter assembly; replacing the filter media with replacement filter media; and securing the front portion to the rear portion by joining the complementary surfaces.
Clause 11—The method of clause 10, further comprising performing the steps of severing the bonded joints and joining further exposed complementary surfaces with each successive reprocessing of the filter assembly.
Clause 12—The method of clause 10 or 11, wherein the complementary surfaces are coaxially disposed within and axially aligned with the one or more bonded joints.
Clause 13—The method of clause 11 or 12, wherein the complementary surfaces are radially and axially offset from the one or more bonded joints in a stepwise configuration.
Clause 14—The method of clause 13, further comprising joining a spacer element between the complementary surfaces with a thickness of the spacer element approximating a thickness of axial offset.
Clause 15—A method of reprocessing for reuse a filter assembly for a smoke evacuation unit, wherein the filter assembly includes a housing comprising a rear side defining a suction outlet, and sides extending from the rear side, a cover coupled to the sides to define a filter chamber, filter media bonded to inner surfaces of the sides, an electric field sensor, and a sensor, the method comprising: accessing the filter chamber of the housing and filter media disposed therein, wherein the filter media is a filter stack comprising one or more sealing elements disposed between a plurality of filter layers to provide a sealed pathway through the filter media; removing at least one of the plurality of layers of the filter stack, wherein at least one of the plurality of layers remains within the filter chamber; providing at least one replacement filter layer corresponding to the at least one of the plurality of filter layers that were removed; positioning the at least one replacement filter layer within the filter chamber; and rejoining a component decoupled or severed to provide the access to the filter chamber.
Clause 16—The method of clause 15, wherein the plurality of filter layers comprises a prefilter layer, an ultra-low particulate air (ULPA) layer, and a carbon layer.
Clause 17—The method of clause 16, wherein the prefilter layer and the ULPA layer are secured to one another and separated from the carbon layer with one of the one or more sealing elements.
Clause 18—A method of assembling a filter assembly for a smoke evacuation unit, the method comprising: securing filter media within a filter chamber of a housing; securing a capacitive sensor within a sensor compartment within an inner casing; securing a shielding layer to an outer surface of the inner casing to form a shielding cover, wherein the shielding layer is at least partially formed from conductive material; and securing the shielding cover to the housing to enclose the capacitive sensor.
Clause 19—The method of clause 18, wherein the step of securing the shielding layer further comprises: aligning alignment apertures defined by the shielding layer with alignment posts of the inner casing such that stakes of the inner casing extend through staking apertures of the conductive layer; and heat staking the stakes of the inner casing.
Clause 20—The method of clause 18 or 19, further comprising: securing a conductive pad to an inner surface of an electronics cover such that at least a portion of the conductive pad is exposed through one or more windows of the electronics cover, and, optionally, wherein the securing is through heat staking; and securing the electronics cover to a side of the housing.
Clause 21—The method of clause 20, further comprising establishing electrical communication between the conductive pad and the shielding layer of the shielding cover.
Clause 22—The method of clause 21, wherein the step of establishing electrical communication further comprises contacting ends of a conductive bridge with each of the conductive pad and the shielding layer.
Clause 23—The method of clause 22, further comprising: coupling an optical sensor to a sensor housing to form a sensor assembly; and securing the sensor assembly to the housing, optionally, by clipping the sensor housing to the side of the housing.
Clause 24—The method of clause 23, further comprising: directing a first wire through a sealing grommet; and seating the sealing grommet in an aperture defined by the side of the housing.
Clause 25—The method of clause 24, further comprising: supporting a printed circuit board (PCB) unit between the electronics cover and the side of the housing; coupling the first wire to each of the optical sensor and the PCB unit; and coupling a second wire to each of the capacitive sensor and the PCB unit.
Clause 26—The method of any one of clauses 19-26, further comprising positioning a sorbent within a liquid collection compartment separated from the filter chamber by a partition of the housing.

1. A method of reprocessing for reuse a filter assembly for a smoke evacuation unit, wherein the filter assembly includes a housing comprising a rear side defining a suction outlet, and sides extending from the rear side, a cover coupled to the sides to define a filter chamber, filter media bonded to inner surfaces of the sides, an electric field sensor, and a sensor, the method comprising:
accessing the filter chamber of the housing;
removing the filter media from the filter chamber by severing at least one of the filter media and an adhesive bond that joins the filter media to the inner surfaces of the sides, wherein at least one of residual material of the adhesive bond or machined material of the housing provides a bonding surface;
providing replacement filter media; and
joining the replacement filter media with the bonding surface to provide a sealed fluid pathway through the replacement filter media.

2. The method of claim 1, wherein the step of removing the filter media further comprises machining the adhesive bond and machining a layer of the inner surfaces of the sides to provide the machined material.

3. The method of claim 2, wherein the step of removing the filter media further comprises debulking the filter media from the adhesive bond prior to the step of machining the adhesive bond and the layer of the inner surfaces.

4. The method of claim 1, wherein the step of accessing the filter chamber further comprises machining the rear side of the housing and around the suction outlet to form a severed opening, and wherein the step of removing the filter media from the filter chamber further comprises removing the filter media through the severed opening.

5. The method of claim 4, further comprising directing the replacement filter media through the severed opening and into the filter chamber.

6. The method of claim 1, wherein the step of accessing the filter chamber further comprises machining around the sides of the housing to sever a rear portion of the housing.

7. The method of claim 6, further comprising rejoining the severed rear portion to the housing after the step of providing the sealed pathway.

8. The method of claim 1, wherein the step of accessing the filter chamber further comprises machining around the sides of the housing on or adjacent to an interface between the housing and the cover.

9. A method of reprocessing for reuse a filter assembly for a smoke evacuation unit, wherein the filter assembly includes a housing comprising a rear side defining a suction outlet, and sides extending from the rear side, a cover coupled to the sides to define a filter chamber, filter media bonded to inner surfaces of the sides, an electric field sensor, and a sensor, the method comprising:
accessing the filter chamber of the housing;
removing the filter media from the filter chamber by severing at least one of the filter media and an adhesive bond that bonds the filter media to the inner surface of the sides;
providing replacement filter media formed from resilient material and sized larger than the filter chamber;
compressing the replacement filter media;
positioning the replacement filter media within the filter chamber under compression; and
releasing the compression such that the resilient material expands within the filter chamber to contact the housing and provide a sealed fluid pathway through the replacement filter media.

10. The method of claim 9, wherein the replacement filter media is positioned within the filter chamber to expand lengthwise to contact an inner surface of the rear side to provide a sealing interface of the sealed fluid pathway.

11. The method of claim 9, wherein the replacement filter media is positioned within the filter chamber to expand widthwise to contact the inner surfaces of the sides to provide a sealing interface of the sealed fluid pathway.

12. The method of claim 9, wherein the replacement filter media includes a filter stack, and a sealing member overmolded or bonded to the filter stack and configured to contact the housing.

13. A method of reprocessing for reuse a filter assembly for a smoke evacuation unit, wherein the filter assembly includes a housing comprising a rear side defining a suction outlet, and sides extending from the rear side, a cover coupled to the sides to define a filter chamber, filter media bonded to inner surfaces of the sides, an electric field sensor, and a sensor, the method comprising:
accessing the filter chamber of the housing;
severing at least one of the filter media and an adhesive bond that bonds the filter media to the inner surfaces of the housing;
removing the filter media from the filter chamber;
providing replacement filter media cartridge comprising a cartridge housing, and a replacement filter media disposed within the cartridge housing; and
joining the cartridge housing to the housing to provide a sealed fluid pathway through the replacement filter media.

14. The method of claim 13, wherein the cartridge housing is joined to one of the inner surfaces of the sides and an inner surface of the rear side to provide a sealing interface of the sealed fluid pathway.

15. The method of claim 13, wherein the step of accessing the filter chamber further comprises machining the rear side of the housing and around the suction outlet to form a severed opening, and wherein the step of removing the filter media from the filter chamber further comprises removing the filter media through the severed opening.

16. The method of claim 15, further comprising directing the replacement filter media through the severed opening and into the filter chamber.

17. The method of claim 13, wherein the step of accessing the filter chamber further comprises machining around the sides of the housing to sever a rear portion of the housing.

18. The method of claim 13, further comprising rejoining the severed rear portion to the housing after the step of providing the sealed pathway.

19. The method of claim 13, wherein the step of accessing the filter chamber further comprises:
decoupling the cover from the housing; and
removing a liquid separator coupled to the housing.

20. The method of claim 13, wherein the step of accessing the filter chamber further comprises machining around the sides of the housing on or adjacent to an interface between the housing and the cover.
